(19) United States
(12) Patent Application Publication
(10) Pub. No.: US 2026/0111141 A1
(43) Pub. Date: Apr. 23, 2026

(54) ATTRIBUTE VALUE DETERMINATION METHOD AND APPARATUS, NON-VOLATILE READABLE STORAGE MEDIUM AND ELECTRONIC DEVICE

(71) Applicant: SUZHOU METABRAIN INTELLIGENT TECHNOLOGY CO., LTD., Suzhou, Jiangsu (CN)

(72) Inventors: Xiaopeng ZHANG, Suzhou, Jiangsu (CN); Tao WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/168,935

(22) PCT Filed: May 28, 2024
(86) PCT No.: PCT/CN2024/095815

§ 371 Date: Sep. 25, 2025

(30) Foreign Application Priority Data
Jul. 6, 2023 (CN) 202310823998.4

(51) Int. Cl. G06F 3/06

(52) U.S. Cl. CPC G06F 3/0655; G06F 3/0604; G06F 3/0679

(57) ABSTRACT

An attribute value determination method, a non-volatile readable storage medium, and an electronic device is provided. The method includes: in a case where there are sensors of the same sensor type in N devices of the same device type, setting a target attribute corresponding to the sensor type; in a case where it is necessary to read an attribute value of the target attribute, sequentially reading the attribute value of each of the N sub-attributes until the attribute value of one of the N sub-attributes is read or the N sub-attributes are traversed; and in a case where the attribute value of one of the N sub-attributes is read, determining the read attribute value of the sub-attribute to be the attribute value of the target attribute.

### CROSS-REFERENCE TO RELATED APPLICATIONS

The present disclosure is a National Stage Entry under 35 U.S.C. § 371 of PCT International Application No. PCT/CN2024/095815, filed on May 28, 2024, which claims the priority of Chinese Patent disclosure 202310823998.4, filed in the China Patent Office on Jul. 6, 2023, and entitled “Attribute Value Determination Method and Apparatus, Non-Volatile Readable Storage Medium and Electronic Device”, the entire contents of each of which are incorporated herein by reference for all purposes.

### TECHNICAL FIELD

Embodiments of the present disclosure relate to the field of computers, and particularly relate to an attribute value determination method, a non-volatile readable storage medium, and an electronic device.

### BACKGROUND

An important function of a BMC (Baseboard Management Controller) is to access a device connected thereto via an I2C (Inter-Integrated Circuit) bus to acquire the state of the device, so as to dynamically monitor the operating state of the device. There are a plurality of sensors in the device, these sensors store sensed data in a register of the device, and the BMC may know the state of the device by reading and writing the register in the device via the I2C bus. The BMC sometimes monitors the values of more than one sensor in the device, for example, simultaneously monitors the temperature of an MCU (Micro-controller Unit) and the temperature of a memory of the device. Many companies produce one kind of devices, and the monitoring methods of the devices produced by different companies even differ significantly, for example, both a GPU produced by the NVIDIA Corporation and a homemade GPU belong to GPUs (Graphic Processing Units), but there are huge differences in their monitoring methods, the temperature of the MCU and the temperature of the memory of the GPU produced by the NVIDIA Corporation are independent of each other, therefore in order to reduce the coupling between the sensors, the monitoring of the temperature of the MCU and the monitoring of the temperature of the memory are independent of each other; however, the temperature of the MCU and the temperature of the memory of the homemade GPU are not independent of each other, and a large number of identical operations are required to read the temperature, therefore in order to reduce the redundancy of codes and ensure the inherent connection of the nodes, the monitoring of the temperature of the MCU and the monitoring of the temperature of the memory are only performed together. Therefore, a large amount of sensor information needs to be saved, which occupies a large amount of memory and hard disk spaces, thereby resulting in an unnecessary waste of the memory and hard disk spaces.

In addition, firstly, either a device of a sub-type 1 or a device of a sub-type 2 is plugged into the same location of a mainboard, but it is impossible to plug devices of two sub-types at the same time, so that the values of the sensors of the device of a certain sub-type cannot be read at the same time, which causes a trouble to the use of a user, and the user may think that the device has a fault if the values cannot be read, thereby increasing the workloads of after-sales personnel and being adverse to the use experience of the user.

Effective solutions have not yet been proposed to solve the problem in the art known to inventors of it being unable to perform compatible monitoring on devices of the same device type produced by different manufacturers due to differences in the devices produced by the different manufacturers.

### SUMMARY

Embodiments of the present disclosure provide an attribute value determination method, a non-volatile readable storage medium, and an electronic device, so as to at least solve the problem of an attribute value determination method in the related art being unable to perform compatible monitoring on devices of the same device type produced by different manufacturers due to differences in the devices produced by the different manufacturers.

According to a first aspect, an attribute value determination method is provided, including: in a case where there are sensors of the same sensor type in N devices of the same device type, setting a target attribute corresponding to the sensor type, wherein the sensors of the same sensor type are configured to collect attribute values of the same type, the attribute value of the target attribute is used for representing the attribute values of the same type that are collected by the sensors, the target attribute is a parent attribute of N sub-attributes, the attribute value of each of the N sub-attributes is used for representing each of the attribute values of the same type that are collected by the sensors in one corresponding device among the N devices, and N is a positive integer greater than or equal to 2; in a case where it is necessary to read the attribute value of the target attribute, sequentially reading the attribute value of each of the N sub-attributes until the attribute value of one of the N sub-attributes is read or the N sub-attributes are traversed; and in a case where the attribute value of one of the N sub-attributes is read, determining the read attribute value of the sub-attribute to be the attribute value of the target attribute.

According to a third aspect, a non-volatile readable storage medium is further provided, wherein a computer program is stored in the non-volatile readable storage medium, and the computer program is configured to execute the steps in any of the above method embodiments when running.

According to a fourth aspect, an electronic device is further provided, including a memory and a processor, wherein a computer program is stored in the memory, and the processor is configured to run the computer program to execute the steps in any of the above method embodiments.

By means of the embodiments of the present disclosure, a target attribute is added to an attribute layer of data processing, in a case where there are sensors of the same sensor type in N devices of the same device type, the target attribute corresponding to the sensor type is set, wherein the sensors of the same sensor type are configured to collect attribute values of the same type, the attribute value of the target attribute is used for representing the attribute values of the same type that are collected by the sensors, the target attribute is a parent attribute of N sub-attributes, the attribute value of each of the N sub-attributes is used for representing each of the attribute values of the same type that are collected by the sensors in one corresponding device among the N devices, and N is a positive integer greater than or equal to 2; in a case where it is necessary to read the attribute value of the target attribute, the attribute value of each of the N sub-attributes is sequentially read until the attribute value of one of the N sub-attributes is read or the N sub-attributes are traversed; and in a case where the attribute value of one of the N sub-attributes is read, the read attribute value of the sub-attribute is determined to be the attribute value of the target attribute. In this way, the problem of the attribute value determination method in the related art being unable to perform compatible monitoring on devices of the same device type produced by different manufacturers due to differences in the devices produced by the different manufacturers is solved, and by setting the target attribute, a plurality of devices of the same device type may correspond to only one sub-attribute. Thus, while compatible reading of attribute information of the sensors is realized, unnecessary memory and hard disk spaces occupied by reading redundant sensor information are reduced, the waste of storage resources is avoided, and the technical effect of performing effective compatible monitoring on devices of the same device type produced by different manufacturers is realized, thereby solving the problem of the attribute value determination method in the related art being unable to perform compatible monitoring on devices of the same device type produced by different manufacturers due to differences in the devices produced by the different manufacturers.

### BRIEF DESCRIPTION OF THE DRAWINGS

FIG. 1 is a schematic architecture diagram of an attribute value determination method system provided in some embodiments of the present disclosure;

FIG. 2 is a schematic structure diagram of an electronic device provided in some embodiments of the present disclosure;

FIG. 3 is a schematic flowchart of an attribute value determination method according to some embodiments of the present disclosure;

FIG. 4 is a schematic flowchart of a BMC monitoring devices according to some embodiments of the present disclosure;

FIG. 5 is a flowchart of storing, in an attribute table, values of sensors acquired by accessing hardware monitors on the basis of attributes of sensors of sub-types according to some embodiments of the present disclosure;

FIG. 6 is a flowchart of reading an attribute of a parent type from attributes of sub-types according to some embodiments of the present disclosure;

FIG. 7 is a structural block diagram of an attribute value determination apparatus according to some embodiments of the present disclosure; and

FIG. 8 is a structural block diagram of a computer system of an electronic device according to some embodiments of the present disclosure.

### DETAILED DESCRIPTION OF THE EMBODIMENTS

In order to enable those skilled in the art to better understand the solutions of the present disclosure, the technical solutions in the embodiments of the present disclosure will be clearly and completely described below in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, should fall into the protection scope of the present disclosure.

It should be noted that, the terms “first” and “second” and the like in the specification, the claims and the above drawings of the present disclosure are used for distinguishing similar objects, and are not necessarily used for describing a specific sequence or precedence order. It should be understood that data used in this way may be exchanged under appropriate circumstances, so that the embodiments of the present disclosure described herein may be implemented in a sequence other than those illustrated or described herein. In addition, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices.

The embodiments of the present disclosure provide an attribute value determination method, a non-volatile readable storage medium, and an electronic device, which may quickly and accurately locate an abnormal autonomous domain. Exemplary disclosures of the electronic device provided in the embodiments of the present disclosure are described below, and the electronic device provided in the embodiments of the present disclosure is implemented as various types of terminal devices, such as a mainboard, a notebook computer, a tablet computer, a desktop computer, a set-top box, a mobile device (e.g., a mobile phone, a portable music player, a personal digital assistant, a dedicated message device and a portable game device), and is also implemented as a server or other types of processing devices. Exemplary disclosures are described below when the device is implemented as a mainboard.

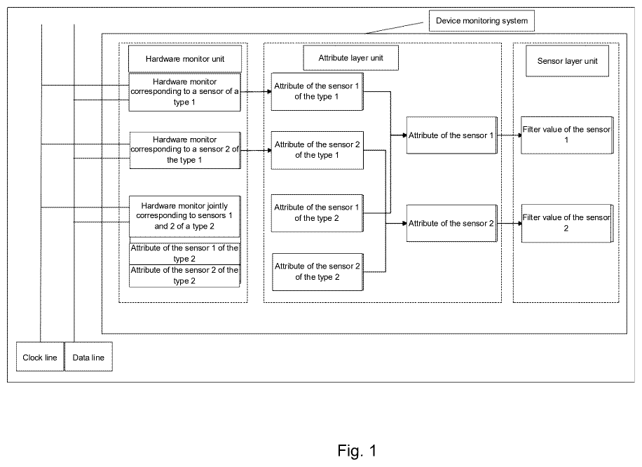

According to one aspect of the embodiments of the present disclosure, an attribute value determination method is provided. In some embodiments of the present disclosure, the attribute value determination method is applied to an attribute value determination method system as shown in FIG. 1. As shown in FIG. 1, the attribute value determination method system 100 may include: a hardware monitor unit 101, an attribute layer unit 102 and a sensor layer unit 103, wherein in order to support the disclosure of one attribute value determination method, the hardware monitor unit 101 includes a plurality of hardware monitors (a hardware monitor corresponding to a sensor 1 of a sub-type 1, a hardware monitor corresponding to a sensor 2 of the sub-type 1, and a hardware monitor jointly corresponding to sensors 1 and 2 of a sub-type 2 are exemplarily illustrated); and on the basis of an I2C bus including a synchronous clock line and a data line, the hardware monitor may access a device of the sub-type 1 and a device of the sub-type 2, which are connected thereto, wherein the sub-type 1 refers to a GPU produced by the Nvidia Corporation, the sub-type 2 refers to a homemade GPU, the sensor 1 refers to the temperature of an MCU, and the sensor 2 refers to the temperature of a memory. Therefore, the states of the devices of different sub-types are acquired to dynamically monitor the operating states of the devices of the sub-types. The attribute value determination method system 100 is connected with a data display device via a network, and the network may include, but is not limited to, at least one of the following: a wired network and a wireless network. The wired network may include, but is not limited to, at least one of the following: a wide area network, a metropolitan area network and a local area network. The wireless network may include, but is not limited to, at least one of the following: WIFI (Wireless Fidelity) and Bluetooth.

The sensor layer unit 103 is configured to acquire, from an attribute table, a filter value corresponding to an attribute value, present the filter value to a target object, and store relevant information of a plurality of sensors, for example, the types of the sensors. The attribute layer unit 102 is configured to process sensor values read by the hardware monitor unit 101 from sensors in devices of different sub-types, to obtain filter values stored in an attribute value table. For example, if the sensor values of sensors of the same sub-type are acquired continuously from the attribute layer unit for ten times, the sensor values is sorted from small to large or from large to small, three maximum values and three minimum values are removed, four intermediate values are averaged to obtain a sensor value finally corresponding to the sensors of the sub-type, and it should be noted that the processed data is referred to as the filter value. Sensor information collected by a plurality of hardware monitors are processed in the attribute layer unit to obtain a response attribute table, in addition, on the basis of the attribute table, attribute information of a sensor of a parent type is also determined on the basis of the attribute table by using a pre-divided correspondence between sub-types and the parent type, and then by monitoring the attribute information of the sensor of the parent type, senors of a plurality of sub-types belonging to the same parent type are monitored. Therefore, by adding an attribute of the parent type corresponding to attributes of the sensors, when devices of sub-types belonging to the parent type are devices produced by different manufacturers, compatible reading of attribute information of the sensors is also realized, thereby achieving the technical effects of reducing unnecessary memory and hard disk spaces occupied by redundant sensor information, avoiding the waste of storage resources and performing compatible monitoring on devices of different sub-types, and thus solving the problem of the attribute value determination method in the related art being unable to perform compatible monitoring on sub-type devices with the same function and produced by different manufacturers due to differences in the sub-type devices produced by the different manufacturers.

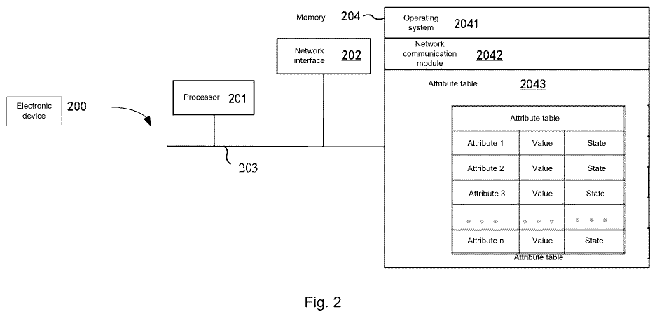

In some embodiments of the present disclosure, the attribute value determination method is executed by an electronic device as shown in FIG. 2. As shown in FIG. 2, the electronic device 200 may include the hardware monitors in the hardware monitor unit 101, and the electronic device 200 includes at least one processor 201, at least one network interface 202, a bus system 203 and a memory 204. The components in the electronic device 200 are coupled together by the bus system 203. It can be understood that the bus system 203 is configured to implement the connection and communication among these components. In addition to a data bus, the bus system 203 further includes a power bus, a control bus and a state signal bus. However, for the clarity of illustration, various buses are labeled as the bus system 203 in FIG. 2 (which is equivalent to the I2C bus in the above embodiments).

The processor 201 is an integrated circuit chip having a signal processing capability, such as a general-purpose processor, a digital signal processor (DSP), or other programmable logic devices, a discrete gate or transistor logic device, and a discrete hardware component, wherein the general-purpose processor is a microprocessor or any conventional processor, etc.

The memory 204 is removable, non-removable, or a combination thereof. Exemplary hardware devices include a solid state memory, a hard disk drive, an optical disk drive, etc. In some embodiments, the memory 204 may include one or more storage devices that are remote from the processor 201 in physical locations.

The memory 204 includes a volatile memory or a non-volatile memory, and may also include both the volatile memory and the non-volatile memory. The non-volatile memory is a read-only memory (ROM), and the volatile memory is a random access memory (RAM). The memory 204 described in the embodiments of the present disclosure is intended to include any memory of a suitable type.

In some embodiments, the memory 204 is capable of storing data to support various operations, examples of these pieces of data include a program, a module and a data structure or a subset or a super-set thereof, which will be exemplified below.

An operating system 2041 includes system programs for processing various basic system services and executing hardware-related tasks, such as a framework layer, a core library layer and a drive layer, which are used for implementing various basic services and processing hardware-based tasks;
a network communication module 2402 is configured to reach other computing devices via one or more (wired or wireless) network interfaces 202, wherein an exemplary network interface 202 includes Bluetooth, wireless fidelity (WiFi), a universal serial bus (USB), and the like; and
an attribute table 2043 includes attribute names, attribute values and attribute states, wherein the attribute name is used for indicating an attribute belongs to a sensor attribute acquired from a device of which sub-type; the attribute value is used for indicating a real-time size of acquired data, for example, if it is necessary to acquire the temperature of an MCU, the corresponding attribute value is a temperature value; and the attribute state is used for indicating whether the attribute name and the attribute value are valid in the table, for example, when the attribute state indicates that the attribute name and the attribute value are invalid, it is indicated that data is not successfully read from a device of a corresponding sub-type, which in return indicates that the device of the sub-type is not plugged or the hardware has a fault, or the like, so the real-time value of the attribute value is denoted as 0, the state is denoted as an abnormal state, and the real-time value and the state are stored in the attribute table.

When devices of sub-types produced by different manufacturers need to be monitored by a BMC, it is assumed that there are two sub-types currently, wherein the sub-type 1 refers to the GPU produced by the Nvidia Corporation, the sub-type 2 refers to the homemade GPU, the sensor 1 refers to the temperature of the MCU, and the sensor 2 refers to the temperature of the memory. Since the monitoring method of the sub-type 1 greatly differs from the monitoring method of the sub-type 2, hardware access cannot be implemented in one hardware monitor. In the related art, an independent hardware monitor is often set up for a device of each sub-type, and the attribute and the sensor value thereof are also independent of each other. In an actual use process, only the device of one sub-type is plugged into the same location of a mainboard, only one of the device of the sub-type 1 and the device of the sub-type 2 is plugged, for example, if the GPU produced by the Nvidia Corporation is plugged, the homemade GPU cannot be plugged, therefore no matter which device is plugged into the sensor layer, the value of the other device cannot be displayed because the device is not plugged. However, for the user, he/she does not consider so much, and always thinks that the sensor having no display value is either unplugged or faulty, which is not conducive to the use and experience of the user, and will also bring a lot of troubles to the after-sales personnel; and moreover, the number of sensors that the BMC monitors simultaneously is limited, corresponding sensor information needs to be saved every time when one sensor is added, since each sensor has a large amount of information to be saved, a large amount of memory and hard disk spaces are occupied, thereby resulting in an unnecessary waste of a large amount of memory and hard disk spaces.

In this regard, an attribute of a parent type is added between an attribute of a sensor of the sub-type 1 and an attribute of a sensor of the sub-type 2 by means of a compatible method for devices of sub-types, and the attribute of the parent type firstly reads the attribute value of the sensor from the attribute of the sensor of the sub-type 1; if the reading is successful, the attribute of the sensor of the sub-type 1 is used as the attribute of the sensor in a device of the parent type; if the reading fails, the attribute of the sensor of the sub-type 2 is read; if the reading is successful, the attribute of the sensor of the sub-type 2 is used as the attribute of the sensor in the device of the parent type; and if the reading still fails, it is indicated that the device of the parent type is not plugged into hardware, and thus the attribute value of the sensor of the device of the parent type is empty; and after an attribute value of the parent type is processed, a filter value is transmitted to a sensor of the parent type to be presented to the user.

By means of the embodiments of the present disclosure, the attribute of the parent type (which is equivalent to the target attribute in the above embodiments) is added to an attribute layer of data processing, after the attribute of the sub-type (which is equivalent to the attribute value collected by the sensor in the above embodiments) of the device of the sub-type (which is equivalent to any of the N devices of the same device type in the above embodiments) is determined, the parent type firstly reads data from the attribute of a device of a first sub-type according to the correspondence between the parent type and the sub-types, and then reads data from the attribute of a device of a second sub-type if the reading fails. Therefore, the attribute of the parent type is filled with the attributes of the devices of the sub-types, and thus no matter how many sub-types corresponds to the attribute of only one sensor of the parent type. In this way, by adding the attribute of the parent type corresponding to the attributes of the sensors, when the devices of the sub-types under the parent type are devices produced by different manufacturers, the compatible reading of attribute information of the sensors is also realized, thereby achieving the technical effects of reducing unnecessary memory and hard disk spaces occupied by redundant sensor information, avoiding the waste of storage resources and performing compatible monitoring on devices of different sub-types, and thus solving the problem of the attribute value determination method in the related art being unable to perform compatible monitoring on sub-type devices with the same function and produced by different manufacturers due to differences in the sub-type devices produced by different manufacturers.

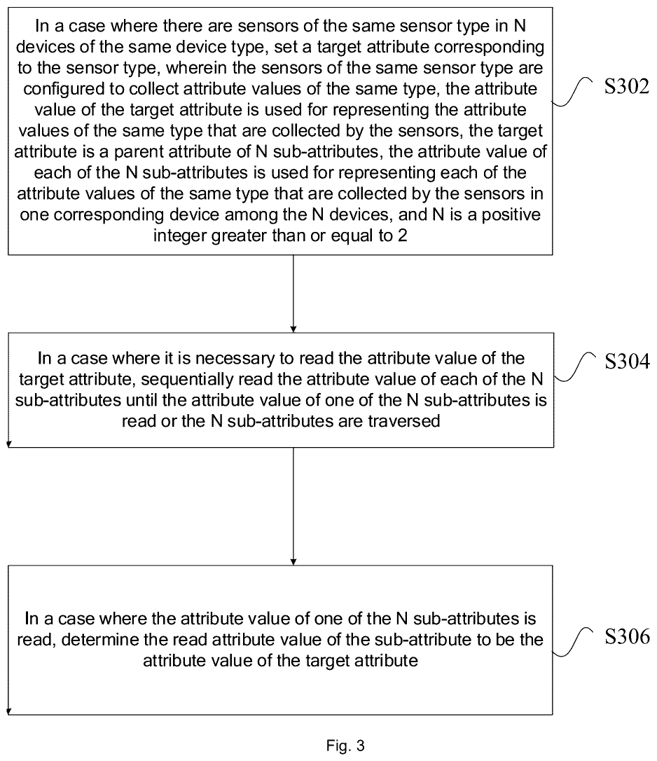

In some embodiments of the present disclosure, the attribute value determination method is separately executed by the sensor layer unit 103, or jointly executed by the sensor layer unit 103 and the hardware monitors in the hardware monitor unit 101, or executed by other processing devices other than the sensor layer unit 103 and the hardware monitor unit 101. As an optional implementation, it is taken as an example that the attribute value determination method in the present embodiment is executed by the sensor layer unit 103. As shown in FIG. 3, the flow of the attribute value determination method includes the following steps:
step S302, in a case where there are sensors of the same sensor type in N devices of the same device type, setting a target attribute corresponding to the sensor type, wherein the sensors of the same sensor type are configured to collect attribute values of the same type, the attribute value of the target attribute is used for representing the attribute values of the same type that are collected by the sensors, the target attribute is a parent attribute of N sub-attributes, the attribute value of each of the N sub-attributes is used for representing each of the attribute values of the same type that are collected by the sensors in one corresponding device among the N devices, and N is a positive integer greater than or equal to 2;
step S304, in a case where it is necessary to read the attribute value of the target attribute, sequentially reading the attribute value of each of the N sub-attributes until the attribute value of one of the N sub-attributes is read or the N sub-attributes are traversed; and
step S306, in a case where the attribute value of one of the N sub-attributes is read, determining the read attribute value of the sub-attribute to be the attribute value of the target attribute.

By means of the above steps, a target attribute is added to an attribute layer of data processing, in a case where there are sensors of the same sensor type in N devices of the same device type, the target attribute corresponding to the sensor type is set, wherein the sensors of the same sensor type are configured to collect attribute values of the same type, the attribute value of the target attribute is used for representing the attribute values of the same type that are collected by the sensors, the target attribute is a parent attribute of N sub-attributes, the attribute value of each of the N sub-attributes is used for representing each of the attribute values of the same type that are collected by the sensors in one corresponding device among the N devices, and N is a positive integer greater than or equal to 2; in a case where it is necessary to read the attribute value of the target attribute, the attribute value of each of the N sub-attributes is sequentially read until the attribute value of one of the N sub-attributes is read or the N sub-attributes are traversed; and in a case where the attribute value of one of the N sub-attributes is read, the read attribute value of the sub-attribute is determined to be the attribute value of the target attribute. In this way, the problem of the attribute value determination method in the related art being unable to perform compatible monitoring on devices of the same device type produced by different manufacturers due to differences in the devices produced by the different manufacturers is solved, and by setting the target attribute, a plurality of devices of the same device type may correspond to only one sub-attribute. Thus, while compatible reading of attribute information of the sensors is realized, unnecessary memory and hard disk spaces occupied by reading redundant sensor information are reduced, the waste of storage resources is avoided, and the technical effect of performing effective compatible monitoring on devices of the same device type produced by different manufacturers is realized, thereby solving the problem of the attribute value determination method in the related art being unable to perform compatible monitoring on devices of the same device type produced by different manufacturers due to differences in the devices produced by the different manufacturers.

In some embodiments of the present disclosure, the attribute value determination method further includes: after setting the target attribute corresponding to the sensor type, executing, by means of N hardware monitors, a read operation on registers corresponding to the sensors in the N devices, wherein the N hardware monitors have a one-to-one correspondence with the N sub-attributes, and the registers are configured to store the attribute values of the same type that are collected by the sensors; and in a case where M hardware monitors among the N hardware monitors read the attribute values of the same type from the registers corresponding to the sensors in M devices among the N devices, writing the attribute values read by the M hardware monitors into a preset attribute table as attribute values of M sub-attributes, wherein M is a positive integer greater than or equal to 1 and less than or equal to N, the attribute table is used for recording the attribute value of each of the N sub-attributes, and the M hardware monitors have a one-to-one correspondence with the M sub-attributes.

In some embodiments, a hardware monitor layer is responsible for processing a service logic operation and accessing different sensors in the devices via an I2C bus to read attribute values collected by corresponding sensors from registers of devices of the same device type that are produced by different manufacturers; and an attribute layer is responsible for reading the attribute values of the sensors that are read from the hardware monitors and storing the attribute values in the attribute table, and the attribute layer also stores relevant information of a lot of sensors, for example, the types of the sensors.

By means of the embodiments of the present disclosure, the attribute values collected by the sensors that have the same sensor type and belong to the devices of the same device type produced by different manufacturers are read by the hardware monitors, and the attribute values and other information corresponding to the attribute values are stored in the preset attribute table, thereby implementing convenient processing of the attribute values.

In some embodiments of the present disclosure, the attribute value determination method further includes: after executing, by means of the N hardware monitors, the read operation on the registers corresponding to the sensors in the N devices, in a case where M is less than N, setting, to be preset target characters, attribute values of N−M sub-attributes among the N sub-attributes other than the M sub-attributes that are recorded in the attribute table, wherein the target characters are used for indicating that the attribute values of the sub-attributes are not read.

In some embodiments of the present disclosure, writing the attribute values read by the M hardware monitors into the preset attribute table as the attribute values of the M sub-attributes includes: writing the attribute value read by an ith hardware monitor among the M hardware monitors into the attribute table as the attribute value of an ith sub-attribute among the M sub-attributes by the following steps, wherein i is a positive integer greater than or equal to 1 and less than or equal to M: in a case where the ith hardware monitor reads an ith group of attribute values from the registers corresponding to the sensors in an ith device among the M devices, determining an ith attribute value to be written according to the ith group of attribute values, wherein the ith group of attribute values includes one or more attribute values of the same type that are collected by the sensors in the ith device; and determining the attribute value of the ith sub-attribute that is recorded in the attribute table to be equal to the ith attribute value.

In some embodiments of the present disclosure, determining the ith attribute value to be written according to the ith group of attribute values includes: in a case where the ith group of attribute values includes one attribute value, determining the one attribute value to be the ith attribute value; and in a case where the ith group of attribute values includes a plurality of attribute values, determining an average value of the ith group of attribute values to be the ith attribute value, or determining an average value of some attribute values in the ith group of attribute values to be the ith attribute value, wherein the some attribute values are attribute values obtained by removing the first P attribute values and the last Q attribute values that are arranged from large to small in the ith group of attribute values, and P and Q are both positive integers greater than or equal to 1.

In some embodiments of the present disclosure, determining the ith attribute value to be written according to the ith group of attribute values includes: in a case where the ith group of attribute values includes one attribute value, determining the one attribute value to be the ith attribute value or in a case where the ith group of attribute values includes a plurality of attribute values, determining an average value of the ith group of attribute values to be the ith attribute value, or determining an average value of some attribute values in the ith group of attribute values to be the ith attribute value, wherein the some attribute values are attribute values obtained by removing the first P attribute values and the last Q attribute values that are arranged from large to small in the ith group of attribute values, and P and Q are both positive integers greater than or equal to 1.

In some embodiments of the present disclosure, determining the ith attribute value to be written according to the ith group of attribute values includes: in a case where the ith group of attribute values includes one attribute value, determining the one attribute value to be the ith attribute value; and in a case where the ith group of attribute values includes a plurality of attribute values, determining an average value of the ith group of attribute values to be the ith attribute value, or determining an average value of some attribute values in the ith group of attribute values to be the ith attribute value, wherein the some attribute values are attribute values obtained by removing the first P attribute values or the last Q attribute values that are arranged from large to small in the ith group of attribute values, and P and Q are both positive integers greater than or equal to 1.

In some embodiments of the present disclosure, determining the ith attribute value to be written according to the ith group of attribute values includes: in a case where the ith group of attribute values includes one attribute value, determining the one attribute value to be the ith attribute value; or in a case where the ith group of attribute values includes a plurality of attribute values, determining an average value of the ith group of attribute values to be the ith attribute value, or determining an average value of some attribute values in the ith group of attribute values to be the ith attribute value, wherein the some attribute values are attribute values obtained by removing the first P attribute values or the last Q attribute values that are arranged from large to small in the ith group of attribute values, and P and Q are both positive integers greater than or equal to 1.

In some embodiments of the present disclosure, setting, to be the preset target characters, the attribute values of the N−M sub-attributes among the N sub-attributes other than the M sub-attributes that are recorded in the attribute table includes: setting the attribute values of the N−M sub-attributes in the attribute table to be 0, and setting the attribute states of the N−M sub-attributes in the attribute table to be abnormal states, wherein the abnormal states are used for indicating that N−M devices corresponding to the N−M sub-attributes are not installed or have hardware faults, and the N−M devices include devices among the N devices other than the M devices; and in a case where the attribute values read by the M hardware monitors are written into the preset attribute table as the attribute values of the M sub-attributes, the method further includes: setting the attribute states of the M sub-attributes in the attribute table to be normal states, wherein the normal states are used for indicating that the M devices corresponding to the M sub-attributes are in working states.

In some embodiments of the present disclosure, in the case of a reading failure, the attribute value of the attribute of the corresponding sensor is set to be 0, thereby marking a sensor subjected to abnormal reading without affecting the normal reading flow and the filling of the attribute table.

In some embodiments of the present disclosure, sequentially reading the attribute value of each of the N sub-attributes until the attribute value of one of the N sub-attributes is read or the N sub-attributes are traversed includes: sequentially reading the attribute value of each of the N sub-attributes from the attribute table according to a preset sequence until the attribute value of one of the N sub-attributes is read or the N sub-attributes are traversed.

In some embodiments of the present disclosure, after the attribute table is filled with the attribute values of the sensors that are collected by different devices, a plurality of sub-attributes in the target attribute read, from the attribute table, the attribute values collected by corresponding sensors, so as to determine the attribute value corresponding to each sub-attribute, and then the numerical value filling of the sub-attributes in the target attribute is quickly completed, therefore attribute content of the target attribute is generated on the basis of reading real-time attribute values corresponding to each type of sensors, so that sensor information to be presented is greatly reduced, and memory resource corresponding to a display interface are saved on.

In some embodiments of the present disclosure, sequentially reading the attribute value of each of the N sub-attributes from the attribute table according to the preset sequence until the attribute value of one of the N sub-attributes is read or the N sub-attributes are traversed includes: in a case where N is 2, reading the attribute value of a first sub-attribute among the N sub-attributes from the attribute table; and in a case where the attribute value of one of the N sub-attributes is read, determining the read attribute value of the sub-attribute to be the attribute value of the target attribute includes: in a case where the attribute value of the first sub-attribute is read, determining the read attribute value of the first sub-attribute to be the attribute value of the target attribute.

In some embodiments of the present disclosure, sequentially reading the attribute value of each of the N sub-attributes from the attribute table according to the preset sequence until the attribute value of one of the N sub-attributes is read or the N sub-attributes are traversed includes: in a case where the attribute value of the first sub-attribute is not read, reading the attribute value of a second sub-attribute among the N sub-attributes from the attribute table; and in a case where the attribute value of one of the N sub-attributes is read, determining the read attribute value of the sub-attribute to be the attribute value of the target attribute includes: in a case where the attribute value of the second sub-attribute is read, determining the read attribute value of the second sub-attribute to be the attribute value of the target attribute.

In some embodiments of the present disclosure, in a case where the attribute value of the first sub-attribute among the N sub-attributes is read from the attribute table, the method further includes: in a case where a reading result obtained by reading the attribute value of the first sub-attribute includes a numerical value within a preset value range, determining the numerical value included in the reading result to be the read attribute value of the first sub-attribute; or in a case where the reading result obtained by reading the attribute value of the first sub-attribute includes the numerical value within the preset value range, and the attribute state of the first sub-attribute further included in the reading result is a normal state, determining the numerical value included in the reading result to be the read attribute value of the first sub-attribute, wherein the normal state is used for indicating that the device corresponding to the first sub-attribute is in a working state. Each GPU device includes sensors of the memory-temperature-sensor type and the MCU-temperature-sensor type.

For example, when there are two devices having a device type of GPU and produced by two different manufacturers, and each GPU device includes a memory temperature sensor and an MCU temperature sensor, when the two GPU devices are installed on a mainboard, since only devices of the same manufacturer are installed on the mainboard, in order to be compatible with devices of different manufacturers, temperature values (which are equivalent to the attribute values in the above embodiments) collected by the memory temperature sensors of the GPU devices installed on the mainboard and temperature values collected by the MCU temperature sensors of the GPU devices installed on the mainboard are displayed in a compatible manner, and the temperature values collected by the two temperature sensors are displayed by the target attributes of the devices. In a case where the target attribute is added to the attribute layer, the target attribute firstly reads attribute values from attribute values collected by all sensors in a first device, if the reading is successful, the attribute values collected by the sensors in the first device are used as attribute values of sub-attributes in the target attribute that correspond to the sensor type of the sensors; if the reading fails, the attribute values collected by all sensors in a second device are read to read the attribute values; if the reading is successful, the attribute values collected by the sensors in the second device are used as the attribute values of the sub-attributes in the target attribute that correspond to the sensor type of the sensors; and if the reading still fails, it is indicated that the device of the target attribute is not plugged into hardware, that is, the GPU device is not installed on the mainboard, therefore the attribute values of the sub-attributes of the target attribute are empty; and it should be noted that after the attribute value of the target attribute is processed, a filter value is transmitted to the sensor corresponding to the target attribute to be presented to the user.

By means of the embodiments of the present disclosure, sensor data of the first device among the N devices of the same device type is read step by step to fill the attribute values of the sub-attributes of the target attribute, and in the case of a reading failure, sensor data of the second device having the same device type as the first device is read, thereby ensuring that the target attribute has the corresponding attribute value regardless of whether the first device or the second device is installed in the mainboard or a device terminal, therefore the case of a display failure will not occur during display to a target object, and thus improving the use experience of the target object.

In some embodiments of the present disclosure, in a case where the attribute value of the first sub-attribute among the N sub-attributes is read from the attribute table, the method further includes: in a case where the reading result obtained by reading the attribute value of the first sub-attribute includes a numerical value beyond the preset value range, determining that the attribute value of the first sub-attribute is not read; or in a case where the reading result obtained by reading the attribute value of the first sub-attribute includes the numerical value beyond the preset value range, and the attribute state of the first sub-attribute further included in the reading result is an abnormal state, determining the numerical value included in the reading result to be the value read attribute value of the first sub-attribute, wherein the abnormal state is used for indicating that the device corresponding to the first sub-attribute is not installed or there is a hardware fault.

According to the embodiments of the present disclosure, by determining the numerical range corresponding to the reading result, it is determined whether the reading of the current sub-attribute is normal, and the attribute states of different sub-attributes are determined according to the numerical values, so that the current sub-attribute can be quickly read, and the installation conditions of the devices of the same device type on the mainboard or a terminal device are also determined according to the read attribute states, thereby improving the use experience of the target object.

In some embodiments of the present disclosure, the method further includes: after setting the target attribute corresponding to the sensor type in a case where there are sensors of the same sensor type in each of N devices of the same device type, determining reading logic of at least two sensors in a jth device among the N devices, where j is a positive integer greater than or equal to 1 and less than or equal to N; in a case where the reading logic indicates that the at least two sensors do not allow independent access, setting the same hardware monitor for the at least two sensors in the jth device, wherein the same hardware monitor is configured to execute a read operation on registers corresponding to the at least two sensors in the jth device, and the registers are configured to store the attribute values of the same type that are collected by the sensors; and in a case where the reading logic indicates that the at least two sensors allow independent access, setting a different hardware monitor for each of the at least two sensors in the jth device, wherein the different hardware monitors are configured to execute the read operation on the registers corresponding to different sensors in the at least two sensors in the jth device.

According to the embodiments of the present disclosure, by setting independent hardware monitors for different types of sub-type devices, the rapid acquisition of attributes of the sensors by the hardware monitors is ensured.

In some embodiments of the present disclosure, the method further includes: after setting the same hardware monitor for the at least two sensors in the jth device,
configuring first monitoring logic for the same hardware monitor, wherein the first monitoring logic is used for instructing to simultaneously read, according to sub-attributes corresponding to the at least two sensors in the jth device, attribute values collected by the at least two sensors.

In some embodiments of the present disclosure, the method further includes: after setting the different hardware monitor for each of the at least two sensors in the jth device, configuring second monitoring logic for different hardware monitors, wherein the second monitoring logic is used for instructing to sequentially read, according to a preset sequence, the attribute values collected by the at least two sensors in the jth device.

It can be understood that, after a different hardware monitor is set for each sensor, in order to ensure the efficiency of the hardware monitors reading data from the sensors, it is also necessary to determine the monitoring logic corresponding to different hardware monitors, and then when the attribute values collected by different sensors are read by using the set hardware monitors, the reading efficiency is greatly improved, and the processing efficiency of the attribute value data is improved.

In some embodiments of the present disclosure, the method further includes: after configuring the second monitoring logic for different hardware monitors, in a case where there is a hardware monitor in the different hardware monitors that is unable to establish a communication connection with corresponding sensors in the at least two sensors, identifying the corresponding sensors as abnormal sensors; and in a case where the number of the abnormal sensors in the at least two sensors is greater than a preset number, determining that the jth device is determined to be not installed.

It can be understood that, when a plurality of sensors of the same device cannot be acquired by using a controller, it is indicated that a hardware exception occurs in the device or that the device is not installed on a target device, and at this time, whether to alert the target object is further selected according to preset reporting logic, to prompt the target object to perform an installation check or a maintenance check on the device.

In some embodiments of the present disclosure, the method further includes: after determining the read attribute value of the sub-attribute to be the attribute value of the target attribute, displaying identifiers of the same type as the target attribute and the attribute value of the target attribute in a target display interface.

In some embodiments of the present disclosure, displaying the identifiers of the same type and the attribute value of the target attribute in the target display interface includes: in a case where the same type is used for representing the temperature of a target device, and the attribute value of the target attribute is used for representing a temperature value of the target device, displaying the temperature of the target device as the temperature value in the target display interface.

It should be noted that, the target display interface includes the identifiers of the same type having a correspondence, and the attribute value of the target attribute, but does not include identifiers of the devices, thereby avoiding the problem in which a part of unread attribute values of the target attribute cannot be normally displayed due to the fact that the identifiers of the devices are displayed.

In some embodiments of the present disclosure, the attribute value determination method further includes: before setting the target attribute corresponding to the sensor type, acquiring an input reading condition for the N devices, and determining, from different sensor types of various sensors in the N devices, sensor types meeting the requirement of the reading condition; and in a case where the number of the sensor types meeting the requirement of the reading condition is greater than a preset number, allowing the setting of corresponding target attribute values for the sensor types.

In some embodiments of the present disclosure, the method further includes: in a case where the number of the sensor types meeting the requirement of the reading condition is less than or equal to the preset number, sending prompt information to the target object; receiving a setting instruction fed back by the target object for the prompt information; and using the setting instruction to adjust the number of sensor types of which the attribute values need to be displayed.

In order to better understand the embodiments of the present disclosure and the technical solutions of some embodiments, the flow of the above attribute value determination method is explained below in conjunction with examples, but the technical solutions of the embodiments of the present disclosure are not limited thereto.

It should be noted that, in order to better understand the technical solutions in the embodiments of the present disclosure, related technical terms are first described:
A BMC (Baseboard Management Controller) is a server-specific management controller, which may automatically monitor the operating state of a server and perform regulation and control according to the current state in time.
An I2C (Inter-Integrated Circuit) is a bidirectional synchronous serial bus, a plurality of devices are connected to the bus, and the devices are divided into a master device and slave devices. The bus is composed of two lines, one is an SDA (Serial Data Line), that is, a synchronous data line, which is configured to transmit data between the master device and the slave devices; and one is an SCL (Serial Clock Line), that is, a synchronous clock line, which is configured to synchronize a time between the master device and the slave devices.

In some embodiments of the present disclosure, an important function of the BMC is to access a device connected thereto via an I2C bus to acquire the state of the device, so as to dynamically monitor the operating state of the device. There are a plurality of sensors in the device, these sensors store sensed data in a register of the device, and the BMC may know the state of the device by reading and writing the register in the device via the I2C bus. The BMC sometimes monitors the values of more than one sensor in the device, for example, simultaneously monitors the temperature of an MCU and the temperature of a memory of the device. Many companies may produce one kind of devices, and the monitoring methods of the devices produced by different companies may even differ significantly, for example, both the GPU produced by the NVIDIA Corporation and the homemade GPU belong to GPUs, but there are huge differences in their monitoring methods, the temperature of the MCU and the temperature of the memory of the GPU produced by the NVIDIA Corporation are independent of each other, therefore in order to reduce the coupling between the sensors, the monitoring of the temperature of the MCU and the monitoring of the temperature of the memory are independent of each other; however, the temperature of the MCU and the temperature of the memory of the homemade GPU are not independent of each other, and a large number of identical operations are required to read the temperature, therefore in order to reduce the redundancy of codes and ensure the inherent connection of the nodes, the monitoring of the temperature of the MCU and the monitoring of the temperature of the memory is only performed together.

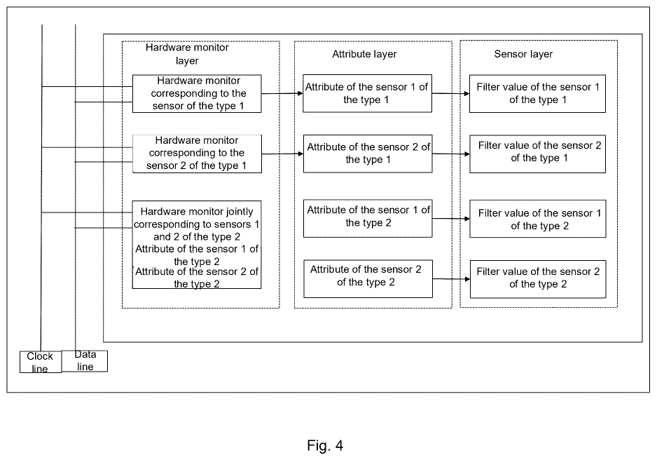

In some embodiments of the present disclosure, FIG. 4 is a schematic flowchart of a BMC monitoring devices according to some embodiments of the present disclosure. As shown in FIG. 4, for ease of understanding, in FIG. 4, a sub-type 1 refers to the GPU produced by the Nvidia Corporation, a sub-type 2 refers to the homemade GPU, a sensor 1 refers to the temperature of the MCU, and a sensor 2 refers to the temperature of the memory. A hardware monitor layer is responsible for processing a service logic operation and accessing a hardware device via the I2C bus to read a corresponding sensor value from a register thereof; an attribute layer is responsible for reading sensor values read from the hardware monitors, performing certain processing on the sensor values (for example, continuously reading the sensor values for ten times, removing three maximum values and three minimum values, and taking an average value of four intermediate values, wherein the processed data is referred to as a filter value), and then placing the sensor values in an attribute table; and a sensor layer is responsible for presenting, to the user, the filter value of the data read from the attribute table, and also storing relevant information of many sensors, for example, the types of the sensors. Since the monitoring method of the sub-type 1 greatly differs from the monitoring method of the sub-type 2, hardware access cannot be implemented in one hardware monitor. Accordingly, an independent hardware monitor is often set up for a device of each sub-type as shown in FIG. 4, and the attribute and sensor value thereof are also independent of each other. In an actual use process, only one sub-type device is plugged into the same location of the mainboard, only one of the sub-type 1 and the sub-type 2 is plugged, for example, if the GPU produced by the Nvidia Corporation is plugged, the homemade GPU cannot be plugged, therefore no matter which device is plugged into the sensor layer, the value of the other device cannot be displayed because the device is not plugged. However, for the user, he/she does not consider so much, and always thinks that the sensor without a displayed value is either unplugged or faulty, which is not conducive to the use and experience of the user, and will also bring a lot of troubles to the after-sales personnel; and the number of sensors that the BMC may monitor simultaneously is limited, sensor information needs to be saved every time when one sensor is added, since each sensor has a large amount of information to be saved, a large amount of memory and hard disk spaces are occupied, resulting in an unnecessary waste of a large amount of memory and hard disk spaces.

To avoid the problem in which GPUs produced by different manufacturers cannot be effectively monitored, and to save memory resources,

In some embodiments of the present disclosure, some embodiments of the present disclosure provide a compatible method for devices monitored by the BMC. In the compatible method, by adding one attribute, the attribute value of a device of the sub-type 1 is first read by using the attribute, if the reading is successful, the value of the sub-type 1 is used as a sensor value, and the attribute value of a device of the sub-type 2 is no longer read; and if the reading of the device of the sub-type 1 fails, the attribute value of the device of the sub-type 2 is then read. In some embodiments of the present disclosure, the embodiments of the present disclosure are illustrated by taking it as an example that a parent type has two sub-types, each sub-type monitors two sensors, and the acquisition modes of the sensors of the two sub-types greatly differ from each other. It should be noted that, there are more than two sub-types, or each sub-type monitors more than two sensors in the actual disclosure process, which is flexibly determined according to actual disclosure scenarios, and which is not excessively limited in the present disclosure.

In some embodiments of the present disclosure, the compatible method is used on the basis of the above examples, and the flow is as follows:
step 1, adding an attribute of a parent type between an attribute of the sensor of the sub-type 1 and an attribute of the sensor of the sub-type 2;
step 2, firstly reading an attribute value of the sensor from the attribute of the sensor of the sub-type 1 via the attribute of the parent type, if the reading is successful, taking the attribute of the sensor of the sub-type 1 as the attribute of the sensor in the device of the parent type, and if the reading fails, reading the attribute of the sensor of the sub-type 2; and if the reading is successful, taking the attribute of the sensor of the sub-type 2 as the attribute of the sensor in the device of the parent type, and if the reading still fails, it is indicated that the device of the parent type is not plugged into hardware, and thus the attribute value of the sensor of the device of the parent type is empty; and
step 3, after the attribute value of the parent type is processed, transmitting a filter value to the sensor of the parent type to be presented to the user.

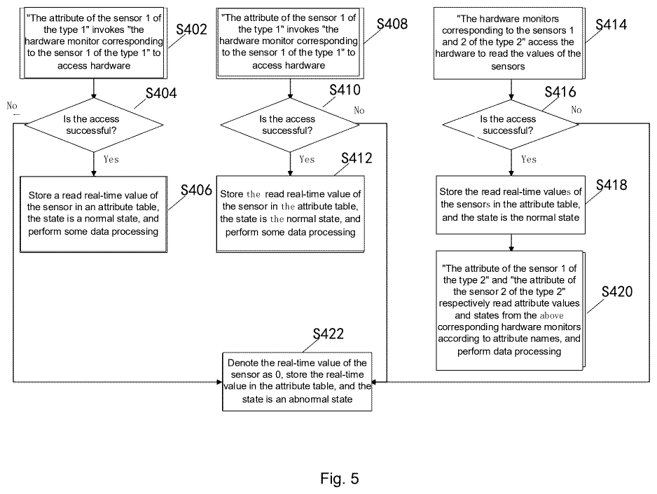

In some embodiments of the present disclosure, FIG. 5 is flowchart of storing, in an attribute table, values of sensors acquired by accessing hardware monitors on the basis of attributes of sensors of sub-types according to some embodiments of the present disclosure. The flow includes the following steps:
step S402, “an attribute of a sensor 1 of the sub-type 1” invoking “a hardware monitor corresponding to the sensor 1 of the sub-type 1” to process a service logic operation (e.g., judging whether a hardware device is in place) and access the hardware device via the I2C bus to acquire the value of the sensor in the device;
step S404, judging whether the access is successful;
step S406, if the access is successful, storing a read real-time value of the sensor in an attribute table, storing the attribute state as a normal state, and performing some data processing. In some embodiments of the present disclosure, the data processing executes the following content: removing three maximum values and three minimum values from values read within the first ten times, performing averaging processing on four intermediate values to obtain a filter value, and taking the filter value as an attribute value of a parent type corresponding to the sub-type;
step S408, “an attribute of a sensor 2 of the sub-type 1” invoking “a hardware monitor of the sensor 2 of the sub-type 1” to process the service logic operation (e.g., judging whether the hardware device is in place) and access the hardware device via the I2C bus to acquire the value of the sensor in the device;
step S410, judging whether the access is successful;
step S412, if the access is successful, storing the read real-time value of the sensor in the attribute table, storing the attribute state as the normal state, and performing some data processing;
step S414, “hardware monitors corresponding to sensors 1 and 2 of the sub-type 2” accessing the hardware to read the values of the sensors;
step S416, judging whether the access is successful;
step S418, if the access is successful, storing the read real-time values of the sensors in the attribute table, and storing the attribute state as the normal state;
step S420, “an attribute of the sensor 1 of the sub-type 2” and “an attribute of the sensor 2 of the sub-type 2” respectively reading attribute values and attribute states from the attribute table temporarily stored in the hardware monitors according to attribute names, and performing data processing;
it should be noted that since the sensor 1 and the sensor 2 of the sub-type 2 are not independent and are related to each other, the sensor 1 and the sensor 2 must be made into one hardware monitor, and after the service logic operation is processed in the hardware monitor, the real-time value of the sensor 1 and the real-time value of the sensor 2 are read out from the register of the device at a time; and
step S422, if the access fails, denoting the real-time value of the sensor as 0, denoting the state as an abnormal state, and storing the real-time value and the abnormal state in the attribute table.

It should be noted that, regarding the above steps S402 to S406 of acquiring “the attribute of the sensor 1 of the sub-type 1”, the steps S408 to S412 of acquiring “the attribute of the sensor 2 of the sub-type 1”, and the steps S414 to S420 of acquiring “the attribute of the sensor 1 of the sub-type 2” and “the attribute of the sensor 2 of the sub-type 2”, the three acquisition modes are executed concurrently, the steps in the flow are executed in sequence, and the step S422 is executed in the case of a failure in the above three flows.

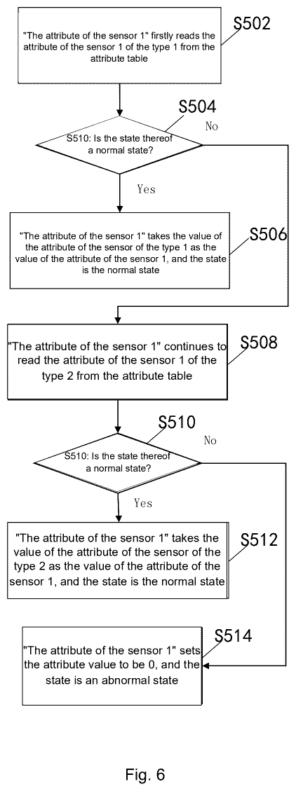

In some embodiments of the present disclosure, FIG. 6 is a flowchart of reading an attribute of a parent type from attributes of sub-types according to some embodiments of the present disclosure. The flow includes the following steps:
step S502, “an attribute of a sensor 1 of the parent type” firstly reading the attribute of the sensor 1 of the sub-type 1 from the attribute table;
step S504, judging whether the read attribute state is a normal state;
step S506, if the read attribute state is the normal state, taking the attribute value thereof as an attribute value of the parent type, “the attribute of the sensor 1 of the parent type” taking the value of the attribute of the sensor 1 of the sub-type 1 as the attribute value thereof, and the attribute state being the normal state;
it should be noted that, since the device of only one sub-type is plugged into the same location on the mainboard, if the device of the sub-type 1 is plugged, the device of the sub-type 2 cannot be plugged, so if the attribute value of the sub-type 1 is read, it is indicated that the device of the sub-type 1 is plugged, that is, the device of the sub-type 2 is not plugged, and the flow ends;
step S508, if the read attribute state is not the normal state, it is indicated that the device of the sub-type 1 is not plugged, then continuing to read the attribute of the sensor 1 of the sub-type 2, that is, “the attribute of the sensor 1 of the parent type” continuing to read the attribute of the sensor 1 of the sub-type 2 from the attribute table;
step S510, judging whether the read attribute state is the normal state;
step S512, if the read attribute state is the normal state, taking the attribute value thereof as the attribute value of the parent type, that is, “the attribute of the sensor 1 of the parent type” taking the attribute value of the sensor of the sub-type 2 as the attribute value thereof, and the attribute state being the normal state; and
step S514, if the read attribute state is not the normal state, it is indicated that the device of the sub-type 2 is not plugged, then setting the attribute value of “the attribute of the sensor 1 of the parent type” to be 0, and setting the state to be an abnormal state, which is expressed as ERROR.

In addition, for other attributes of the parent type, the flows of the steps S502 to S514 are executed cyclically, for example, “the attribute of the sensor 2 of the parent type” is determined.

By means of the above steps, regardless of whether the device of the sub-type 1 or the device of the sub-type 2 is plugged, there is only one attribute of the parent type, then the “sensor 1” and the “sensor 2” respectively read the filter values of the sensors from the attribute of the sensor 1 of the parent type and the attribute of the sensor 2 of the parent type and present the filter values to the user.

It should be noted that the above flows are all illustrated by taking it as an example that there are two sub-types, and each sub-type monitors two sensors, but it is not limited to the two sub-types in fact, each sub-type is not limited to monitor only two sensors, and any embodiment is implemented according to the present disclosure as long as the conditions of the present disclosure are met.

To sum up, by means of the above embodiments, an attribute of the parent type is added to the attribute layer, the parent type is firstly read from the attribute of the sub-type 1, is then read from the attribute of the sub-type 2 in the case of a reading failure, and is transmitted to the sensor corresponding to the parent type for the check of the user. By using this method, no matter how many sub-types there are, they only correspond to one sensor, thereby reducing unnecessary memory and hard disk spaces occupied by redundant sensors and avoiding waste; since only device is plugged into the same location at the same time, if the device of each sub-type corresponds to one sensor, the unplugged device of the sub-type cannot be read all the time, causing a trouble to the use of the user; in the method, all sub-types correspond to one sensor of the parent type, thereby avoiding the problem in which the values of the sensors of the sub-types are not read due to the fact that devices of other sub-types are not plugged, thus avoiding causing a trouble to the use of the user, avoiding an increase in the workloads of the after-sales personnel, and bettering meeting the logic; and furthermore, the method is simple and easy to implement.

It should be noted that, regarding the above method embodiments, for simplicity of description, all the above method embodiments are expressed as a series of action combinations, but those skilled in the art should know that the present disclosure is not limited by the described sequence of actions, because according to the present disclosure, some steps are performed in other sequences or simultaneously. Secondly, those skilled in the art should also know that all the embodiments described in the specification belong to optional embodiments, and the involved actions and modules are not necessarily required by the present disclosure.

By means of the descriptions of the above implementations, those skilled in the art may clearly understand that, the method according to the above embodiments is implemented by software plus a necessary general-purpose hardware platform, and of course is also implemented by hardware, but the former is a better implementation in many cases. Based on such an understanding, the technical solutions of the present disclosure essentially or the part contributing to the related art are embodied in the form of a software product, and the computer software product is stored in a non-volatile storage medium (e.g., an ROM/RAM, a magnetic disk and an optical disk), and includes several instructions for enabling a terminal device (which may be a mobile phone, a computer, a server, or a hardware monitor, and the like) to execute the method in various embodiments of the present disclosure.

According to another aspect of the embodiments of the present disclosure, an attribute value determination apparatus is further provided, wherein the apparatus is configured to implement the attribute value determination method provided in the above embodiments, and what has been described will not be repeated again. As used below, the term “module” may implement a combination of software and hardware of a predetermined function, or the term “module” implements a combination of software of a predetermined function, or the term “module” implements a combination of hardware of a predetermined function. In some embodiments, although the apparatus described in the following embodiments is implemented in software, the implementation of hardware or a combination of software and hardware is also possible and conceivable.

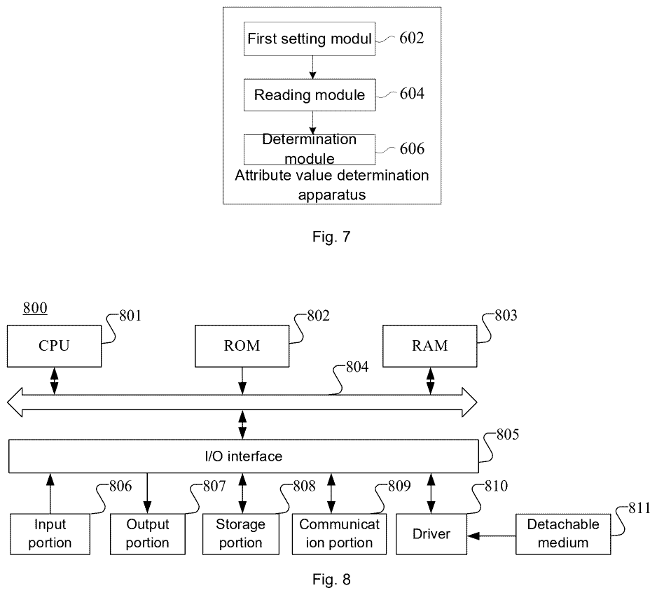

FIG. 7 is a structural block diagram of an attribute value determination apparatus according to some embodiments of the present disclosure. As shown in FIG. 7, the apparatus includes:
a first setting module 602, configured to: in a case where there are sensors of the same sensor type in N devices of the same device type, set a target attribute corresponding to the sensor type, wherein the sensors of the same sensor type are configured to collect attribute values of the same type, the attribute value of the target attribute is used for representing the attribute values of the same type that are collected by the sensors, the target attribute is a parent attribute of N sub-attributes, the attribute value of each of the N sub-attributes is used for representing each of the attribute values of the same type that are collected by the sensors in one corresponding device among the N devices, and N is a positive integer greater than or equal to 2;
a reading module 604, configured to: in a case where it is necessary to read the attribute value of the target attribute, sequentially read the attribute value of each of the N sub-attributes until the attribute value of one of the N sub-attributes is read or the N sub-attributes are traversed; and
a determination module 605, configured to: in a case where the attribute value of one of the N sub-attributes is read, determine the read attribute value of the sub-attribute to be the attribute value of the target attribute.

It should be noted that, the first setting module 602 in some embodiments is configured to execute the above step S302, the reading module 604 in some embodiments is configured to execute the above step S304, and the determination module 605 in some embodiments is configured to execute the above step S306.

By means of the embodiments provided in the present disclosure, a target attribute is added to an attribute layer of data processing, in a case where there are sensors of the same sensor type in N devices of the same device type, the target attribute corresponding to the sensor type is set, wherein the sensors of the same sensor type are configured to collect attribute values of the same type, the attribute value of the target attribute is used for representing the attribute values of the same type that are collected by the sensors, the target attribute is a parent attribute of N sub-attributes, the attribute value of each of the N sub-attributes is used for representing each of the attribute values of the same type that are collected by the sensors in one corresponding device among the N devices, and N is a positive integer greater than or equal to 2; in a case where it is necessary to read the attribute value of the target attribute, the attribute value of each of the N sub-attributes is sequentially read until the attribute value of one of the N sub-attributes is read or the N sub-attributes are traversed; and in a case where the attribute value of one of the N sub-attributes is read, the read attribute value of the sub-attribute is determined to be the attribute value of the target attribute. In this way, the problem of the attribute value determination method in the related art being unable to perform compatible monitoring on devices of the same device type produced by different manufacturers due to differences in the devices produced by the different manufacturers is solved, and by setting the target attribute, a plurality of devices of the same device type may correspond to only one sub-attribute. Thus, while compatible reading of attribute information of the sensors is realized, unnecessary memory and hard disk spaces occupied by reading redundant sensor information are reduced, the waste of storage resources is avoided, and the technical effect of performing effective compatible monitoring on devices of the same device type produced by different manufacturers is realized, thereby solving the problem of the attribute value determination method in the related art being unable to perform compatible monitoring on devices of the same device type produced by different manufacturers due to differences in the devices produced by the different manufacturers.

In some embodiments of the present disclosure, the apparatus further includes: a writing module, configured to: after setting the target attribute corresponding to the sensor type, execute, by means of N hardware monitors, a read operation on registers corresponding to the sensors in the N devices, wherein the N hardware monitors have a one-to-one correspondence with the N sub-attributes, and the registers are configured to store the attribute values of the same type that are collected by the sensors; and in a case where M hardware monitors among the N hardware monitors read the attribute values of the same type from the registers corresponding to the sensors in M devices among the N devices, write the attribute values read by the M hardware monitors into a preset attribute table as attribute values of M sub-attributes, wherein M is a positive integer greater than or equal to 1 and less than or equal to N, the attribute table is used for recording the attribute value of each of the N sub-attributes, and the M hardware monitors have a one-to-one correspondence with the M sub-attributes.

In some embodiments, a hardware monitor layer is responsible for processing a service logic operation and accessing different sensors in the devices via an I2C bus to read attribute values collected by corresponding sensors from registers of devices of the same device type that are produced by different manufacturers; and an attribute layer is responsible for reading the attribute values of the sensors that are read from the hardware monitors and storing the attribute values in the attribute table, and the attribute layer also stores relevant information of a lot of sensors, for example, the types of the sensors.

By means of the embodiments of the present disclosure, the attribute values collected by the sensors that have the same sensor type and belong to the devices of the same device type produced by different manufacturers are read by the hardware monitors, and the attribute values and other information corresponding to the attribute values are stored in the preset attribute table, thereby implementing convenient processing of the attribute values.

In some embodiments of the present disclosure, the writing module is further configured to: after executing, by means of the N hardware monitors, the read operation on the registers corresponding to the sensors in the N devices, in a case where M is less than N, set, to be preset target characters, attribute values of N−M sub-attributes among the N sub-attributes other than the M sub-attributes that are recorded in the attribute table, wherein the target characters are used for indicating that the attribute values of the sub-attributes are not read.

In some embodiments of the present disclosure, the writing module is further configured to: write the attribute value read by an ith hardware monitor among the M hardware monitors into the attribute table as the attribute value of an ith sub-attribute among the M sub-attributes by the following steps, wherein i is a positive integer greater than or equal to 1 and less than or equal to M: in a case where the ith hardware monitor reads an ith group of attribute values from the registers corresponding to the sensors in an ith device among the M devices, determine an ith attribute value to be written according to the ith group of attribute values, wherein the ith group of attribute values includes one or more attribute values of the same type that are collected by the sensors in the ith device; and determine the attribute value of the ith sub-attribute that is recorded in the attribute table to be equal to the ith attribute value.

In some embodiments of the present disclosure, the writing module is further configured to: in a case where the ith group of attribute values includes one attribute value, determine the one attribute value to be the ith attribute value; and in a case where the ith group of attribute values includes a plurality of attribute values, determine an average value of the ith group of attribute values to be the ith attribute value, or determine an average value of some attribute values in the ith group of attribute values to be the ith attribute value, wherein the some attribute values are attribute values obtained by removing at least one of the first P attribute values and the last Q attribute values that are arranged from large to small in the ith group of attribute values, and P and Q are both positive integers greater than or equal to 1.

In some embodiments of the present disclosure, the writing module is further configured to: in a case where the ith group of attribute values includes one attribute value, determine the one attribute value to be the ith attribute value; or in a case where the ith group of attribute values includes a plurality of attribute values, determine an average value of the ith group of attribute values to be the ith attribute value, or determine an average value of some attribute values in the ith group of attribute values to be the ith attribute value, wherein the some attribute values are attribute values obtained by removing at least one of the first P attribute values or the last Q attribute values that are arranged from large to small in the ith group of attribute values, and P and Q are both positive integers greater than or equal to 1.

In some embodiments of the present disclosure, the writing module is further configured to: in a case where the ith group of attribute values includes one attribute value, determine the one attribute value to be the ith attribute value; and in a case where the ith group of attribute values includes a plurality of attribute values, determine an average value of the ith group of attribute values to be the ith attribute value, or determine an average value of some attribute values in the ith group of attribute values to be the ith attribute value, wherein the some attribute values are attribute values obtained by removing at least one of the first P attribute values or the last Q attribute values that are arranged from large to small in the ith group of attribute values, and P and Q are both positive integers greater than or equal to 1.

In some embodiments of the present disclosure, the writing module is further configured to: in a case where the ith group of attribute values includes one attribute value, determine the one attribute value to be the ith attribute value; or in a case where the ith group of attribute values includes a plurality of attribute values, determine an average value of the ith group of attribute values to be the ith attribute value, or determine an average value of some attribute values in the ith group of attribute values to be the ith attribute value, wherein the some attribute values are attribute values obtained by removing at least one of the first P attribute values and the last Q attribute values that are arranged from large to small in the ith group of attribute values, and P and Q are both positive integers greater than or equal to 1.

In some embodiments of the present disclosure, the writing module is further configured to: set the attribute values of the N−M sub-attributes in the attribute table to be 0, and set the attribute states of the N−M sub-attributes in the attribute table to be abnormal states, wherein the abnormal states are used for indicating that N−M devices corresponding to the N−M sub-attributes are not installed or have hardware faults, and the N−M devices include devices among the N devices other than the M devices; and in a case where the attribute values read by the M hardware monitors are written into the preset attribute table as the attribute values of the M sub-attributes, the method further includes: setting the attribute states of the M sub-attributes in the attribute table to be normal states, wherein the normal states are used for indicating that the M devices corresponding to the M sub-attributes are in working states.

In some embodiments of the present disclosure, in the case of a reading failure, the attribute value of the attribute of the corresponding sensor is set to be 0, thereby marking a sensor subjected to abnormal reading without affecting the normal reading flow and the filling of the attribute table.

In some embodiments of the present disclosure, the reading module is further configured to sequentially read the attribute value of each of the N sub-attributes from the attribute table according to a preset sequence until the attribute value of one of the N sub-attributes is read or the N sub-attributes are traversed.

In some embodiments of the present disclosure, after the attribute table is filled with the attribute values of the sensors that are collected by different devices, a plurality of sub-attributes in the target attribute read, from the attribute table, the attribute values collected by corresponding sensors, so as to determine the attribute value corresponding to each sub-attribute, and then the numerical value filling of the sub-attributes in the target attribute is quickly completed, therefore attribute content of the target attribute can be generated on the basis of reading real-time attribute values corresponding to each type of sensors, so that sensor information to be presented is greatly reduced, and memory resource corresponding to a display interface are saved on.

In some embodiments of the present disclosure, the determination module is further configured to: in a case where N is 2, read the attribute value of a first sub-attribute among the N sub-attributes from the attribute table; and in a case where the attribute value of one of the N sub-attributes is read, determining the read attribute value of the sub-attribute to be the attribute value of the target attribute includes: in a case where the attribute value of the first sub-attribute is read, determining the read attribute value of the first sub-attribute to be the attribute value of the target attribute.

In some embodiments of the present disclosure, the reading module is further configured to: in a case where the attribute value of the first sub-attribute is not read, read the attribute value of a second sub-attribute among the N sub-attributes from the attribute table; and in a case where the attribute value of one of the N sub-attributes is read, determining the read attribute value of the sub-attribute to be the attribute value of the target attribute includes: in a case where the attribute value of the second sub-attribute is read, determining the read attribute value of the second sub-attribute to be the attribute value of the target attribute.

In some embodiments of the present disclosure, the reading module is further configured to: in a case where a reading result obtained by reading the attribute value of the first sub-attribute includes a numerical value within a preset value range, determine the numerical value included in the reading result to be the read attribute value of the first sub-attribute; or in a case where the reading result obtained by reading the attribute value of the first sub-attribute includes the numerical value within the preset value range, and the attribute state of the first sub-attribute further included in the reading result is a normal state, determine the numerical value included in the reading result to be the read attribute value of the first sub-attribute, wherein the normal state is used for indicating that the device corresponding to the first sub-attribute is in a working state.

For example, when there are two devices having a device type of GPU and produced by two different manufacturers, and each GPU device includes sensors of the memory temperature sensor and an MCU temperature sensor, when the two GPU devices are installed on a mainboard, since only devices of the same manufacturer may be installed on the mainboard, in order to be compatible with devices of different manufacturers, temperature values (which are equivalent to the attribute values in the above embodiments) collected by the memory temperature sensors of the GPU devices installed on the mainboard and temperature values collected by the MCU temperature sensors of the GPU devices installed on the mainboard are displayed in a compatible manner, and the temperature values collected by the two temperature sensors are displayed by the target attributes of the devices. In a case where the target attribute is added to the attribute layer, the target attribute firstly reads attribute values from attribute values collected by all sensors in a first device, if the reading is successful, the attribute values collected by the sensors in the first device are used as attribute values of sub-attributes in the target attribute that correspond to the sensor type of the sensors; if the reading fails, the attribute values collected by all sensors in a second device are read to read the attribute values; if the reading is successful, the attribute values collected by the sensors in the second device are used as the attribute values of the sub-attributes in the target attribute that correspond to the sensor type of the sensors; and if the reading still fails, it is indicated that the device of the target attribute is not plugged into hardware, that is, the GPU device is not installed on the mainboard, therefore the attribute values of the sub-attributes of the target attribute are empty; and it should be noted that after the attribute value of the target attribute is processed, a filter value is transmitted to the sensor corresponding to the target attribute to be presented to the user.

By means of the embodiments of the present disclosure, sensor data of the first device among the N devices of the same device type is read step by step to fill the attribute values of the sub-attributes of the target attribute, and in the case of a reading failure, sensor data of the second device having the same device type as the first device is read, thereby ensuring that the target attribute has the corresponding attribute value regardless of whether the first device or the second device is installed in the mainboard or a device terminal, therefore the case of a display failure will not occur during display to a target object, and thus improving the use experience of the target object.

In some embodiments of the present disclosure, the reading module further includes: a state unit, configured to: in a case where the attribute value of the first sub-attribute among the N sub-attributes is read from the attribute table, and in a case where the reading result obtained by reading the attribute value of the first sub-attribute includes a numerical value beyond the preset value range, determine that the attribute value of the first sub-attribute is not read; or in a case where the reading result obtained by reading the attribute value of the first sub-attribute includes the numerical value beyond the preset value range, and the attribute state of the first sub-attribute further included in the reading result is an abnormal state, determine the numerical value included in the reading result to be a value read attribute value of the first sub-attribute, wherein the abnormal state is used for indicating that the device corresponding to the first sub-attribute is not installed or there is a hardware fault.

According to the embodiments of the present disclosure, by determining the numerical range corresponding to the reading result, it is determined whether the reading of the current sub-attribute is normal, and the attribute states of different sub-attributes are determined according to the numerical values, so that the current sub-attribute can be quickly read, and the installation conditions of the devices of the same device type on the mainboard or a terminal device can also be determined according to the read attribute states, thereby improving the use experience of the target object.

In some embodiments of the present disclosure, the apparatus further includes: a second setting module, configured to: after setting the target attribute corresponding to the sensor type in a case where there are sensors of the same sensor type in each of N devices of the same device type, determine reading logic of at least two sensors in a jth device among the N devices, where j is a positive integer greater than or equal to 1 and less than or equal to N; in a case where the reading logic indicates that the at least two sensors do not allow independent access, set the same hardware monitor for the at least two sensors in the jth device, wherein the same hardware monitor is configured to execute a read operation on registers corresponding to the at least two sensors in the jth device, and the registers are configured to store the attribute values of the same type that are collected by the sensors; and in a case where the reading logic indicates that the at least two sensors allow independent access, set a different hardware monitor for each of the at least two sensors in the jth device, wherein the different hardware monitors are configured to execute the read operation on the registers corresponding to different sensors in the at least two sensors in the jth device.

According to the embodiments of the present disclosure, by setting independent hardware monitors for different types of sub-type devices, the rapid acquisition of attributes of the sensors by the hardware monitors is ensured.

In some embodiments of the present disclosure, the second setting module further includes: a first configuration unit, configured to: after setting the same hardware monitor for the at least two sensors in the jth device, configure first monitoring logic for the same hardware monitor, wherein the first monitoring logic is used for instructing to simultaneously read, according to sub-attributes corresponding to the at least two sensors in the jth device, attribute values collected by the at least two sensors.

In some embodiments of the present disclosure, the second setting module further includes: a second configuration unit, configured to: after setting the different hardware monitor for each of the at least two sensors in the jth device, configure second monitoring logic for different hardware monitors, wherein the second monitoring logic is used for instructing to sequentially read, according to a preset sequence, the attribute values collected by the at least two sensors in the jth device.

It can be understood that, after a different hardware monitor is set for each sensor, in order to ensure the efficiency of the hardware monitors reading data from the sensors, it is also necessary to determine the monitoring logic corresponding to different hardware monitors, and then when the attribute values collected by different sensors are read by using the set hardware monitors, the reading efficiency is greatly improved, and the processing efficiency of the attribute value data is improved.

In some embodiments of the present disclosure, the second setting module further includes: an identification unit, configured to: after configuring the second monitoring logic for different hardware monitors, in a case where there is a hardware monitor in the different hardware monitors that is unable to establish a communication connection with corresponding sensors in the at least two sensors, identify the corresponding sensors as abnormal sensors; and the second setting module further includes: a determination unit, configured to: in a case where the number of the abnormal sensors in the at least two sensors is greater than a preset number, determine that the jth device is determined to be not installed.

It can be understood that, when a plurality of sensors of the same device cannot be acquired by using a controller, it is indicated that a hardware exception occurs in the device or that the device is not installed on a target device, and at this time, whether to alert the target object is further selected according to preset reporting logic, to prompt the target object to perform an installation check or a maintenance check on the device.

In some embodiments of the present disclosure, the apparatus further includes: a display module, configured to: after determining the read attribute value of the sub-attribute to be the attribute value of the target attribute, display identifiers of the same type and the attribute value of the target attribute in a target display interface.

In some embodiments of the present disclosure, the displaying module is further configured to: in a case where the same type is used for representing the temperature of a target device, and the attribute value of the target attribute is used for representing a temperature value of the target device, display the temperature of the target device as the temperature value in the target display interface.

It should be noted that, the target display interface includes the identifiers of the same type having a correspondence, and the attribute value of the target attribute, but does not include identifiers of the devices, thereby avoiding the problem in which a part of unread attribute values of the target attribute cannot be normally displayed due to the fact that the identifiers of the devices are displayed.

In some embodiments of the present disclosure, the apparatus further includes: a requirement module, configured to: before setting the target attribute corresponding to the sensor type, acquire an input reading condition for the N devices, and determine, from different sensor types of various sensors in the N devices, sensor types meeting the requirement of the reading condition; and in a case where the number of the sensor types meeting the requirement of the reading condition is greater than a preset number, allow the setting of corresponding target attribute values for the sensor types.

In some embodiments of the present disclosure, the requirement module further includes: an adjustment unit, configured to: in a case where the number of the sensor types meeting the requirement of the reading condition is less than or equal to the preset number, send prompt information to the target object; receive a setting instruction fed back by the target object for the prompt information; and use the setting instruction to adjust the number of sensor types of which the attribute values need to be displayed.

It should be noted that the above modules are implemented by software or hardware. For the latter, the above modules may be implemented in the following manners, but are not limited thereto: the above modules are all located in the same processor; or the above modules are respectively located in different processors in any combination forms.

According to yet another aspect of the embodiments of the present disclosure, a non-volatile readable storage medium is further provided, wherein a computer program is stored in the non-volatile readable storage medium, and the computer program is configured to execute the steps in any of the above method embodiments when running.

In some embodiments of the present disclosure, the non-volatile readable storage medium may include, but is not limited to, various media capable of storing the computer program, such as a USB flash disk, a read-only memory (ROM), a random access memory (RAM), a removable hard disk, a magnetic disk, or an optical disk.

According to one aspect of the present disclosure, a computer program product is provided, including a computer program, wherein the computer program or instruction includes program codes for executing the method shown in the flowchart. In such an embodiment, the computer program may be downloaded and installed from at least one of a network via a communication portion 809, and installed from a detachable medium 811. When the computer program is executed by a central processing unit 801, various functions provided in the embodiments of the present disclosure are executed. The sequence numbers of the embodiments of the present disclosure are merely for description, but do not represent advantages and disadvantages of the embodiments.

According to one aspect of the present disclosure, a computer program product is provided, including a computer program, wherein the computer program or instruction includes program codes for executing the method shown in the flowchart. In such an embodiment, the computer program may be downloaded and installed from at least one of a network via a communication portion 809, or installed from a detachable medium 811. When the computer program is executed by a central processing unit 801, various functions provided in the embodiments of the present disclosure are executed. The sequence numbers of the embodiments of the present disclosure are merely for description, but do not represent advantages and disadvantages of the embodiments.

FIG. 8 schematically illustrates a structural block diagram of a computer system for implementing an electronic device according to an embodiment of the present disclosure. As shown in FIG. 8, the computer system 800 includes a central processing unit 801 (CPU), which may execute various suitable actions and processes in accordance with a program stored in a read-only memory (ROM) 802 or a program loaded from a storage portion 808 into a random access memory (RAM) 803. In the random access memory 803, various programs and data required by the operations of the system are also stored. The central processing unit 801, the read-only memory 802 and the random access memory 803 are connected with each other via a bus 804. An input/output (I/O) interface 805 is also connected to the bus 804.

The following components are connected to the input/output interface 805: an input portion 806, including a keyboard, a mouse, and the like; an output portion 807, including, for example, a cathode ray tube (CRT), a liquid crystal display (LCD), and a loudspeaker; a storage portion 808, including a hard disk, and the like; and a communication portion 809, including, for example, a local area network card and a modem. The communication portion 809 executes communication processing via a network such as the Internet. A driver 810 is also connected to the input/output interface 805 as needed. The detachable medium 811, such as a magnetic disk, an optical disk, a magneto-optical disk and a semiconductor memory, is installed on the driver 810 as needed, so that the computer program read from the detachable medium 811 is installed in the storage portion 808 as needed.

In particular, according to the embodiments of the present disclosure, the processes described in the method flowcharts is implemented as computer software programs. For example, the embodiments of the present disclosure include a computer program product, which includes a computer program carried on a computer-readable medium, and the computer program includes program codes for executing the method illustrated in the flowcharts. In such embodiments, the computer program is downloaded and installed from at least one of a network via the communication portion 809, and installed from the detachable medium 811. When the computer program is executed by the central processing unit 801, various functions defined in the system of the present disclosure are executed.

In particular, according to the embodiments of the present disclosure, the processes described in the method flowcharts is implemented as computer software programs. For example, the embodiments of the present disclosure include a computer program product, which includes a computer program carried on a computer-readable medium, and the computer program includes program codes for executing the method illustrated in the flowcharts. In such embodiments, the computer program is downloaded and installed from at least one of a network via the communication portion 809, or installed from the detachable medium 811. When the computer program is executed by the central processing unit 801, various functions defined in the system of the present disclosure are executed.

It should be noted that the computer system 800 of the electronic device shown in FIG. 8 is only an example, and should not bring any limitation to the functions and scope of use of the embodiments of the present disclosure.

According to yet another aspect of the embodiments of the present disclosure, an electronic device is further provided, including a memory and a processor, wherein a computer program is stored in the memory, and the processor is configured to run the computer program to execute the steps in any of the above method embodiments.

In some embodiments of the present disclosure, the electronic device may further include a transmission device and an input/output device, wherein the transmission device is connected with an input/output resource pool, and the input/output device is connected with the input/output resource pool.

For optional examples in the present embodiment, references are made to the examples described in the above embodiments and exemplary implementations, and thus details are not described again in the present embodiment.

Obviously, it should be understood by those skilled in the art that, the modules or steps in the above embodiments of the present disclosure may be implemented by a general-purpose computing apparatus, may be concentrated on a single computing apparatus or distributed on a network composed of a plurality of computing apparatuses, and may also be implemented by program codes executable by the computing apparatus, therefore the modules or steps may be stored in a storage apparatus to be executed by the computing apparatus, and in some cases, the shown or described steps may be executed in a sequence different from that herein, or the steps are respectively made into various integrated circuit modules, or a plurality of modules or steps therein may be made into a single integrated circuit module for implementation. In this way, the embodiments of the present disclosure are not limited to any particular hardware and software combination.

The above descriptions are only optional embodiments of the present disclosure, and are not intended to limit the embodiments of the present disclosure, and for those skilled in the art, the embodiments of the present disclosure may have various changes and modifications. Any modifications, equivalent replacements, improvements, and the like, made within the principles of the embodiments of the present disclosure, shall fall within the protection scope of the embodiments of the present disclosure.

1. An attribute value determination method, comprising:
in a case where there are sensors of the same sensor type in N devices of the same device type, setting a target attribute corresponding to a sensor type, wherein the sensors of the same sensor type are configured to collect attribute values of a same type, an attribute value of the target attribute is used for representing the attribute values of the same type that are collected by the sensors, the target attribute is a parent attribute of N sub-attributes, an attribute value of each of the N sub-attributes is used for representing each of the attribute values of the same type that are collected by the sensors in one corresponding device among the N devices, and N is a positive integer greater than or equal to 2;
in a case where it is necessary to read the attribute value of the target attribute, sequentially reading an attribute value of each of the N sub-attributes until an attribute value of one of the N sub-attributes is read or the N sub-attributes are traversed; and
in a case where the attribute value of one of the N sub-attributes is read, determining a read attribute value of the sub-attribute to be the attribute value of the target attribute.

2. The attribute value determination method as claimed in claim 1, wherein the attribute value determination method further comprises: after setting the target attribute corresponding to the sensor type,
executing, by means of N hardware monitors, a read operation on registers corresponding to the sensors in the N devices, wherein the N hardware monitors have a one-to-one correspondence with the N sub-attributes, and the registers are configured to store the attribute values of the same type that are collected by the sensors; and
in a case where M hardware monitors among the N hardware monitors read the attribute values of the same type from the registers corresponding to the sensors in M devices among the N devices, writing an attribute values read by the M hardware monitors into a preset attribute table as attribute values of M sub-attributes, wherein M is a positive integer greater than or equal to 1 and less than or equal to N, the attribute table is used for recording the attribute value of each of the N sub-attributes, and the M hardware monitors have a one-to-one correspondence with the M sub-attributes.

3. The attribute value determination method as claimed in claim 2, wherein the attribute value determination method further comprises: after executing, by means of the N hardware monitors, the read operation on the registers corresponding to the sensors in the N devices,
in a case where M is less than N, setting, to be preset target characters, attribute values of N−M sub-attributes among the N sub-attributes other than the M sub-attributes that are recorded in the attribute table, wherein the target characters are used for indicating that the attribute values of the sub-attributes are not read.

4. The attribute value determination method as claimed in claim 2, wherein writing the attribute values read by the M hardware monitors into the preset attribute table as the attribute values of the M sub-attributes comprises:
writing an attribute value read by an ith hardware monitor among the M hardware monitors into the attribute table as an attribute value of an ith sub-attribute among the M sub-attributes by the following steps, wherein i is a positive integer greater than or equal to 1 and less than or equal to M:
in a case where the ith hardware monitor reads an ith group of attribute values from the registers corresponding to the sensors in an ith device among the M devices, determining an ith attribute value to be written according to the ith group of attribute values, wherein the ith group of attribute values comprises one or more attribute values of the same type that are collected by the sensors in the ith device; and
determining the attribute value of the ith sub-attribute that is recorded in the attribute table to be equal to the ith attribute value.

5. The attribute value determination method as claimed in claim 4, wherein determining the ith attribute value to be written according to the ith group of attribute values comprises:
in a case where the ith group of attribute values comprises one attribute value, determining the one attribute value to be the ith attribute value; and
in a case where the ith group of attribute values comprises a plurality of attribute values, determining an average value of the ith group of attribute values to be the ith attribute value, or determining an average value of some attribute values in the ith group of attribute values to be the ith attribute value, wherein the some attribute values are attribute values obtained by removing the first P attribute values and the last Q attribute values that are arranged from large to small in the ith group of attribute values, and P and Q are both positive integers greater than or equal to 1.

6. The attribute value determination method as claimed in claim 3, wherein,
setting, to be the preset target characters, the attribute values of the N−M sub-attributes among the N sub-attributes other than the M sub-attributes that are recorded in the attribute table comprises: setting the attribute values of the N−M sub-attributes in the attribute table to be 0, and setting the attribute states of the N−M sub-attributes in the attribute table to be abnormal states, wherein the abnormal states are used for indicating that N−M devices corresponding to the N−M sub-attributes are not installed or have hardware faults, and the N−M devices include devices among the N devices other than the M devices; and
in a case where the attribute values read by the M hardware monitors are written into the preset attribute table as the attribute values of the M sub-attributes, the method further comprises: setting the attribute states of the M sub-attributes in the attribute table to be normal states, wherein the normal states are used for indicating that the M devices corresponding to the M sub-attributes are in working states.

7. The attribute value determination method as claimed in claim 2, wherein sequentially reading the attribute value of each of the N sub-attributes until the attribute value of one of the N sub-attributes is read or the N sub-attributes are traversed comprises:
sequentially reading the attribute value of each of the N sub-attributes from the attribute table according to a preset sequence until the attribute value of one of the N sub-attributes is read or the N sub-attributes are traversed.

8. The attribute value determination method as claimed in claim 7, wherein,
sequentially reading the attribute value of each of the N sub-attributes from the attribute table according to the preset sequence until the attribute value of one of the N sub-attributes is read or the N sub-attributes are traversed comprises: in a case where N is 2, reading an attribute value of a first sub-attribute among the N sub-attributes from the attribute table; and
in a case where the attribute value of one of the N sub-attributes is read, determining the read attribute value of the sub-attribute to be the attribute value of the target attribute comprises: in a case where the attribute value of the first sub-attribute is read, determining a read attribute value of the first sub-attribute to be the attribute value of the target attribute.

9. The attribute value determination method as claimed in claim 8, wherein,
sequentially reading the attribute value of each of the N sub-attributes from the attribute table according to the preset sequence until the attribute value of one of the N sub-attributes is read or the N sub-attributes are traversed comprises: in a case where the attribute value of the first sub-attribute is not read, reading an attribute value of a second sub-attribute among the N sub-attributes from the attribute table; and
in a case where the attribute value of one of the N sub-attributes is read, determining the read attribute value of the sub-attribute to be the attribute value of the target attribute comprises: in a case where the attribute value of the second sub-attribute is read, determining the read attribute value of the second sub-attribute to be the attribute value of the target attribute.

10. The attribute value determination method as claimed in claim 8, wherein in a case where the attribute value of the first sub-attribute among the N sub-attributes is read from the attribute table, the method further comprises:
in a case where a reading result obtained by reading the attribute value of the first sub-attribute comprises a numerical value within a preset value range, determining the numerical value comprised in the reading result to be the read attribute value of the first sub-attribute; or
in a case where the reading result obtained by reading the attribute value of the first sub-attribute comprises the numerical value within the preset value range, and the attribute state of the first sub-attribute further comprised in the reading result is a normal state, determining the numerical value comprised in the reading result to be the read attribute value of the first sub-attribute, wherein the normal state is used for indicating that the device corresponding to the first sub-attribute is in a working state.

11. The attribute value determination method as claimed in claim 9, wherein in a case where the attribute value of the first sub-attribute among the N sub-attributes is read from the attribute table, the method further comprises:
in a case where a reading result obtained by reading the attribute value of the first sub-attribute comprises a numerical value beyond the preset value range, determining that the attribute value of the first sub-attribute is not read; or
in a case where the reading result obtained by reading the attribute value of the first sub-attribute comprises the numerical value beyond the preset value range, and the attribute state of the first sub-attribute further comprised in the reading result is an abnormal state, determining the numerical value comprised in the reading result to be a value read attribute value of the first sub-attribute, wherein the abnormal state is used for indicating that the device corresponding to the first sub-attribute is not installed or there is a hardware fault.

12. The attribute value determination method as claimed in claim 1, wherein the method further comprises: after setting the target attribute corresponding to the sensor type in a case where there are sensors of the same sensor type in each of N devices of the same device type,
determining reading logic of at least two sensors in a jth device among the N devices, where j is a positive integer greater than or equal to 1 and less than or equal to N;
in a case where the reading logic indicates that the at least two sensors do not allow independent access, setting a same hardware monitor for the at least two sensors in the jth device, wherein the same hardware monitor is configured to execute a read operation on registers corresponding to the at least two sensors in the jth device, and the registers are configured to store the attribute values of the same type that are collected by the sensors; and
in a case where the reading logic indicates that the at least two sensors allow independent access, setting a different hardware monitor for each of the at least two sensors in the jth device, wherein the different hardware monitors are configured to execute a read operation on the registers corresponding to different sensors in the at least two sensors in the jth device.

13. The attribute value determination method as claimed in claim 12, wherein the method further comprises: after setting the same hardware monitor for the at least two sensors in the jth device,
configuring first monitoring logic for the same hardware monitor, wherein the first monitoring logic is used for instructing to simultaneously read, according to sub-attributes corresponding to the at least two sensors in the jth device, attribute values collected by the at least two sensors.

14. The attribute value determination method as claimed in claim 12, wherein after setting the different hardware monitor for each of the at least two sensors in the jth device, the method further comprises:
configuring second monitoring logic for different hardware monitors, wherein the second monitoring logic is used for instructing to sequentially read, according to a preset sequence, the attribute values collected by the at least two sensors in the jth device.

15. The attribute value determination method as claimed in claim 14, wherein the attribute value determination method further comprises: after configuring the second monitoring logic for different hardware monitors,
in a case where there is a hardware monitor in the different hardware monitors that is unable to establish a communication connection with corresponding sensors in the at least two sensors, identifying the corresponding sensors as abnormal sensors; and
in a case where a number of the abnormal sensors in the at least two sensors is greater than a preset number, determining that the jth device is determined to be not installed.

16. The attribute value determination method as claimed in claim 1, wherein the attribute value determination method further comprises: after determining the read attribute value of the sub-attribute to be the attribute value of the target attribute,
displaying identifiers of a same type as the target attribute and the attribute value of the target attribute in a target display interface.

17. The attribute value determination method as claimed in claim 16, wherein displaying the identifiers of the same type and the attribute value of the target attribute in the target display interface comprises:
in a case where the same type is used for representing the temperature of a target device, and the attribute value of the target attribute is used for representing a temperature value of the target device, displaying the temperature of the target device as the temperature value in the target display interface.

18. (canceled)

19. A non-volatile readable storage medium, wherein a computer program is stored in the non-volatile readable storage medium, and the computer program is configured to implement, in a case where executed by a processor, wherein the attribute value determination method comprising: in a case where there are sensors of the same sensor type in N devices of the same device type, setting a target attribute corresponding to a sensor type, wherein the sensors of the same sensor type are configured to collect attribute values of a same type, an attribute value of the target attribute is used for representing the attribute values of the same type that are collected by the sensors, the target attribute is a parent attribute of N sub-attributes, an attribute value of each of the N sub-attributes is used for representing each of the attribute values of the same type that are collected by the sensors in one corresponding device among the N devices, and N is a positive integer greater than or equal to 2;
in a case where it is necessary to read the attribute value of the target attribute, sequentially reading an attribute value of each of the N sub-attributes until an attribute value of one of the N sub-attributes is read or the N sub-attributes are traversed; and
in a case where the attribute value of one of the N sub-attributes is read, determining a read attribute value of the sub-attribute to be the attribute value of the target attribute.

20. An electronic device, comprising a memory, a processor, and a computer program stored on the memory and capable of running on the processor, wherein the processor implements the steps of the attribute value determination method, wherein the attribute value determination method comprising in a case where there are sensors of the same sensor type in N devices of the same device type, setting a target attribute corresponding to a sensor type, wherein the sensors of the same sensor type are configured to collect attribute values of a same type, an attribute value of the target attribute is used for representing the attribute values of the same type that are collected by the sensors, the target attribute is a parent attribute of N sub-attributes, an attribute value of each of the N sub-attributes is used for representing each of the attribute values of the same type that are collected by the sensors in one corresponding device among the N devices, and N is a positive integer greater than or equal to 2;
in a case where it is necessary to read the attribute value of the target attribute, sequentially reading an attribute value of each of the N sub-attributes until an attribute value of one of the N sub-attributes is read or the N sub-attributes are traversed; and
in a case where the attribute value of one of the N sub-attributes is read, determining a read attribute value of the sub-attribute to be the attribute value of the target attribute.

21. The attribute value determination method as claimed in claim 4, wherein determining the ith attribute value to be written according to the ith group of attribute values comprises:
in a case where the ith group of attribute values comprises one attribute value, determining the one attribute value to be the ith attribute value; and
in a case where the ith group of attribute values comprises a plurality of attribute values, determining an average value of the ith group of attribute values to be the ith attribute value, or determining an average value of some attribute values in the ith group of attribute values to be the ith attribute value, wherein the some attribute values are attribute values obtained by removing the first P attribute values or the last Q attribute values that are arranged from large to small in the ith group of attribute values, and P and Q are both positive integers greater than or equal to 1.
